(19) United States
(12) Patent Application Publication
(10) Pub. No.: US 2021/0192496 A1
(43) Pub. Date: Jun. 24, 2021

(54) DIGITAL WALLET REWARD OPTIMIZATION USING REVERSE-ENGINEERING

(71) Applicant: PayPal, Inc., San Jose, CA (US)

(72) Inventor: Andrija Gregovic, Singapore (SG)

(21) Appl. No.: 16/719,673

(22) Filed: Dec. 18, 2019

(51) Int. Cl. G06Q 20/36; G06Q 20/40; G06Q 20/32; G06Q 20/22; G06N 20/00

(52) U.S. Cl. CPC G06Q 20/36; G06Q 20/40; G06N 20/00; G06Q 20/227; G06Q 20/3278

(57) ABSTRACT

Systems and methods for digital wallet reward optimization using reverse-engineering and machine learning models include determining that a transaction is at a checkout and obtaining digital wallet information. A first machine learning model classifies the transaction as able to produce a potential reward for a set of cards provided in the digital wallet information and predicts a first reward amount for each card. A second machine learning model, that has extracted campaign definitions for each of the cards, classifies the transaction as able to produce a potential reward for each of the cards based on the extracted campaign definitions and predicts a second reward amount for each of the cards. A third machine learning model evaluates the first and second reward amounts to determine a final predicted reward amount for each card of the set of cards. A card having the greatest reward amount may be recommended to the user.

### TECHNICAL FIELD

The present disclosure generally relates to machine learning and reverse engineering, and more particularly, using machine learning and reverse engineering to optimize digital content in the form of rewards in digital wallet applications.

### BACKGROUND

A digital wallet generally refers to an application running on an electronic device that allows a user to store and manage electronic versions of credit cards, debit cards, gift cards, identification cards, and other digital wallet assets. For example, a user can enter information about a physical card into a digital wallet software application to create a corresponding virtual digital wallet card asset. The user then may access and present the virtual card, for example, using a smart phone or other portable computing device without carrying around a physical wallet or the physical card itself.

Card issuers in some cases provide reward programs associated with certain cards. For example, a cardholder may receive a reward based on purchases that are charged to the card. Such rewards may include cash back based on a purchase amount (e.g., 1% cash back) or points that may be accumulated and redeemed for various goods or services (e.g., travel flight miles, travel expense credit, dining purchase credit, gift cards, etc.). In some instances, the benefits may be restricted to certain transactions. For example, a card user may receive 2% cash back for gas purchases or 3x points for grocery purchases, 1% cash back for restaurant purchases, etc. In other instances, a benefit may not be received until a user meets a certain threshold of spending within a window of time. For example, spending $3000 within the first three months after registering a new card may earn a bonus reward of $150.

Thus, the cards that provide rewards generally have rules/conditions that must be followed/satisfied in order to receive the reward. A user who has several different cards in their digital wallet may want to use a card for a transaction that will provide a greatest reward. As there may be numerous rules and the rules may oftentimes change without notice, it may be difficult to know which card to use for a particular transaction to optimize a reward amount. Receiving digital rule sets from card issuers is oftentimes impractical due to non-universal file formats between card issuers. Sometimes card issuers do not provide digital rule set files at all. Therefore, there exists a need to improve upon digital wallet technology to provide a user-friendly, convenient, and response time efficient way to optimize rewards.

### BRIEF DESCRIPTION OF THE FIGURES

FIG. 1 illustrates a system architecture suitable for implementing examples of the present disclosure in accordance with one or more embodiments;

FIG. 2 illustrates a flow diagram of a process for optimizing digital wallet rewards in accordance with one or more embodiments of the present disclosure;

FIG. 3 illustrates a flow diagram of a process for optimizing digital wallet rewards in accordance with one or more embodiments of the present disclosure;

FIG. 4 illustrates a block diagram of a machine learning system suitable for optimizing digital wallet rewards using reverse-engineering in accordance with one or more embodiments of the present disclosure;

FIGS. 5-7 illustrate a graphical user interface for displaying a digital wallet in accordance with one or more embodiments of the present disclosure; and

FIG. 8 illustrates a block diagram of a computer system in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Card issuers may provide rewards to cardholders for using cards in transactions. The cardholders may link cards to a digital wallet (e.g., an account in a digital wallet application). Rewards may include cash back in the form of cash or credit, travel points/miles, points, etc. Generally, the rewards may have a monetary value or approximate Monetary value. For example, points/miles may be redeemed in different fashions to provide different monetary values. For example, a reward program may have a 1:1 point to cent value if redeemed for cash or a 1:2.5 point to cent value if redeemed for a travel trip booked through a rewards program associated with the card issuer or partnered travel service provider.

The reward amount earned and whether the reward is given at all may be based on rules associated with the card. For example, a rule may be that 1% of a transaction value is earned as cash back for transactions at restaurants. Another example rule may be 4 points are earned for every dollar spent on travel (e.g., hotel, flight, rideshare, taxi, public transportation, etc.). Another example rule may be that 2% of a transaction value is earned in the form of cash back for all transactions. Another example rule may be 1.5% of a transaction value is earned in the form of credit redeemable in a rideshare application for grocery store purchases (e.g., 1.50 dollars in the form of credit for use in a rideshare application is earned for spending 100 dollars at the grocery store). Another example rule may be that 5% of the transaction value is earned as a reward in the form of redeemable points for transactions with certain merchants during certain months of the year as long as a user has opted in to the reward program for the particular card (e.g., opt-in bonus reward category cards, revolving bonus category cards).

A user may have several reward cards linked to their digital wallet. The user may want to optimize a reward earned for each transaction that the user performs, but as the user collects more cards in the digital wallet, the accumulation of rules associated with the different cards become cumbersome to remember or manage. Thus, a card could be used in a transaction where a different card, if used, would have provided a greater reward. Using a card that does not provide the greatest reward leaves the user with a non-optimal digital wallet reward.

The present disclosure describes techniques that provide an improvement over prior digital wallet technology by reverse-engineering data aggregated from a plurality of reward recipients using machine-learning. By reverse-engineering data aggregated from a plurality of reward recipients, inefficiencies in retrieving reward rules from card issuers can be avoided. By not relying on the retrieval of reward rules from card issuers and instead using real-time data collected from a plurality of reward recipients as they earn rewards (e.g., crowdsourcing reward data from reward recipients), a digital wallet reward optimization system may provide more up-to-date machine learning recommendations.

In an embodiment, a system determines that a user device associated with a user is performing a checkout for a transaction. The system may obtain digital wallet card information from a digital wallet account associated with the user in response to determining that the user is performing the transaction.

A first sub-model of a first machine learning model may receive transaction information associated with the transaction and digital wallet information and may classify the transaction as capable of providing a protentional reward. In this regard, the first sub-model of the first machine learning model may be trained to perform binary classification of a transaction.

If the first sub-model of the first machine learning model classified the transaction as capable of providing a protentional reward, a second sub-model of the first machine learning model may predict a reward amount corresponding to various digital wallet cards in the digital wallet associated with the user. In this regard, the second sub-model of the first machine learning model may be trained to predict reward amounts for the various digital wallet cards based on learned examples from previous/historic transaction data aggregated from a plurality of users who performed transactions using various cards.

A second machine learning model comprised of sub-models may output another prediction for reward amounts corresponding to the various digital wallet cards. The second machine learning model may operate independent from the first machine learning model. In some embodiments, the second machine learning model may extract rules/conditions from a text description of the reward campaigns of the various digital wallet cards and summarize rules for each card where the conditions may be used to classify the transaction as able to return a potential reward and the rules may be used to generate the predicted reward amount by the second machine learning model.

An ensemble machine learning model may provide a final reward prediction for each card based on the predictions for each card from the first machine learning model and the second machine learning model. By using independent machine learning models with different algorithms for predicting reward amounts, the ensemble model's reward prediction can be more accurate as the final reward prediction. With the final reward prediction for each card, an optimal card of the digital wallet can be determined by comparing the final reward predictions between the various cards. The optimal card may be displayed in a graphical user interface as a recommendation for the user to select for use in the transaction.

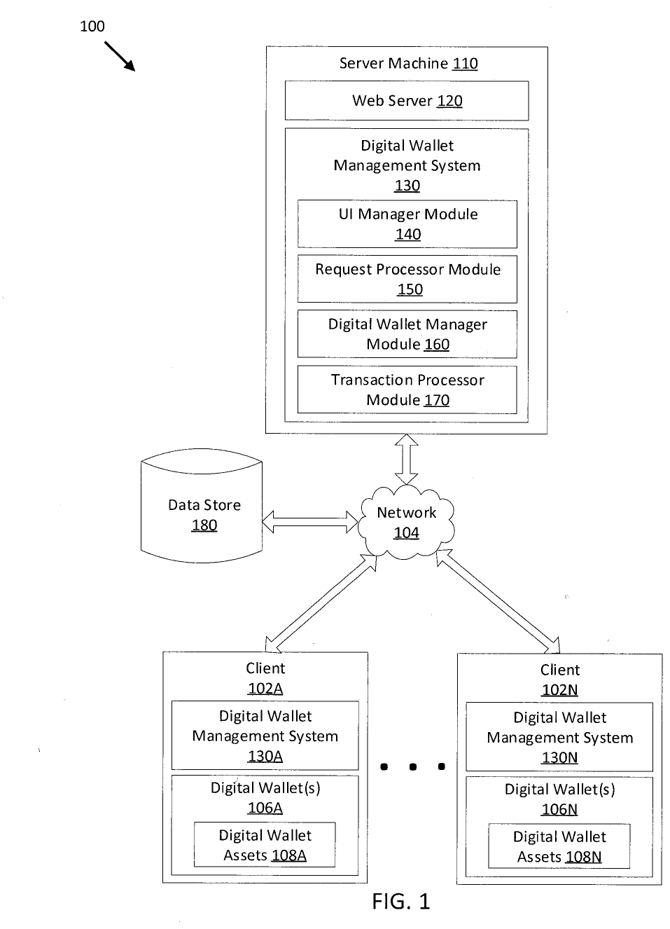

FIG. 1 illustrates an exemplary system architecture 100 in which examples of the present disclosure may be implemented. System architecture 100 includes a server machine 110, a data store 180, and client machines 102A-102N connected to a network 104. Network 104 may be a public network (e.g., the Internet), a private network (e.g., a local area network (LAN) or wide area network (WAN)), or a combination thereof. In an example, network 104 may include the Internet and/or one or more intranets, wired networks, wireless networks, and/or other appropriate types of communication networks. In one example, network 104 may comprise a wireless telecommunications network (e.g., cellular phone network) adapted to communicate with other communication networks, such as the Internet.

Data store 180 is persistent storage that is capable of storing various types of data, such as text, audio, video, and image content. In some examples, data store 180 might be a network-attached file server, while in other examples, data store 180 might be an object-oriented database, a relational database, or other suitable database for a given application.

Client machines 102A-102N may be personal computers (PC), laptops, mobile phones, tablet computers, server computers, wearable computing devices, or any other suitable computing devices. Client machines 102A-102N may run an operating system (OS) that manages hardware and software of the client machines 102A-102N. A browser (not shown) may run on the client machines (e.g., on the OS of the client machines). The browser may be a web browser that can access content and services provided by a web server 120 of server machine 110. Other types of computer programs and computer scripts also may run on client machines 102A-102N.

Client machines 102A-102N each may include a respective digital wallet management system (130A, 130N), to manage one or more respective digital wallets (106A, 106N) and corresponding digital wallet assets (108A, 108N) and provide predictions/recommendations as described herein. Server machine 110 also may include a digital wallet management system 130 for managing a digital wallet 106A, 106N and digital wallet assets 108A, 108N stored on a client machine 102A, on stored server machine 110, or stored on another computing device.

A digital wallet 106A, 106N generally refers to an electronic device or computer software running on an electronic device that allows a user to manage various personal credentials, accounts, and other assets that have been linked or loaded to digital wallet 106A or 106N. Examples of digital wallet assets 108A, 108N may include, but are not limited to, one or more credit cards, debit cards, mobile payment accounts, money transfer accounts, loyalty cards, rewards cards, offers, coupons, advertisements, bank accounts, checking accounts, investment accounts, electronic marketplace accounts, driver's licenses, boating licenses, pilot licenses, professional licenses, passports, birth certificates, government issued identification cards, a marriage license, deeds to real property, deeds to personal property, car insurance identification, home insurance identification, automobile insurance identification, motorcycle insurance identification, umbrella or supplemental insurance identification, a green card, a permanent resident card, a voter registration card, an employer ID, a military ID, a club ID, a fitness membership ID, a public transit card, a roadside assistance membership, a medical insurance card, a vision insurance card, a dental insurance card, etc. In some examples, digital wallet assets 108A, 108N may be associated with one or more digital wallet(s) 106A, 108N on a single client machine 102A or on different client machines 102A-102N (e.g., joint accounts, a marriage license, etc.).

In an example, each digital wallet asset 108A has identifying information and one or more other attributes. Such attributes may include textual data, numeric data, alphanumeric data, images, videos, sounds, encrypted data, unencrypted data, etc. Digital wallet assets 108A may share attribute data (e.g., a residential address, a shipping address, a photo ID, etc.) between one another.

Server machine 110 may be a rackmount server, a router computer, a personal computer, a portable digital assistant, a mobile phone, a laptop computer, a tablet computer, a camera, a video camera, a netbook, a desktop computer, a media center, or any combination thereof. Server machine 110 may include a web server 120 and a digital wallet management system 130. In some examples, web server 120 and digital wallet management system 130 may run on one or more different machines.

Web server 120 may provide text, audio, and video images from data store 180 to client machines 102A-102N. Web server 120 also may provide web-based application services, logic, and/or digital wallet management system 130A, 130N updates to client machines 102A-102N. Client machines 102A-102N may locate, access, and consume various forms of content and services from web server 120 using applications, such as a web browser, web servers, application servers, computer programs, etc. Web server 120 also may receive text, audio, video, and image content from clients 102A-102N that is saved in data store 180 for purposes that may include preservation and distribution of content. Further, web server 120 and/or digital wallet management system 130 may receive API requests from various client machines 102A-102N.

In an example, web server 120 is coupled to one or more applications servers (not shown) that provide applications, services, and digital wallet management system 130 APIs to client machines 102A-102N. For example, web server 120 may provide clients 102A-102N with access to one or more application services of a digital wallet management system 130. Such functionality also may be provided, for example, as one or more different web applications, standalone applications, systems, plug-ins, web browser extensions, and application programming interfaces (APIs). In some examples, plug-ins and extensions also may be referred to, individually or collectively, as “add-ons.”

In an example, some client machines 102A-102N may include applications associated with a service provided by server machine 110. In one example, one or more device types (e.g., smart phones, smart televisions, tablet computers, wearable devices, smart home computer systems, etc.) may use applications to access content provided by, to issue commands to server machine 110, and/or to receive content from server machine 110 without visiting or using web pages.

In an example, functions performed by server machine 110 and/or web server 120 also may be performed by the client machines 102A-102N, in whole or in part. In addition, the functionality attributed to a particular component may be performed by different or multiple components operating together. Server machine 110 may be accessed as a service provided to other systems or devices via appropriate application programming interfaces (APIs), and thus is not limited to use with websites.

In an example, a digital wallet management system 130, 130A, 130N may include a user interface (UI) management module 140, a request processor module 150, a digital wallet management module 160, and a transaction processor module 170. In some examples, functionality associated with UI management module 140, request processor module 150, digital wallet management module 160, and transaction processor module 170 may be combined, divided, and organized in various arrangements on one or more computing devices.

In an example, user interface (UI) management module 140 of digital wallet management system 130 enables a user of a client machine 102A to manage digital wallet assets graphically in a digital wallet software application. For example, UI management module 140 may provide a user of the digital wallet software application with various screens and graphical components that allow the user to add/link digital wallet assets 108A to a digital wallet 106A, to input digital wallet asset 108A data, to update digital wallet asset 108A data, to remove digital wallet assets 108A from a digital wallet 106A, to create attribute-based relationships between digital wallet assets 108A, to create event or activity-based relationships between digital wallet assets 108A, to select digital wallet assets 108A for use in a transaction, to view reward predictions for digital wallet assets 108A and recommendations for optimal assets to use for a transaction, and/or to perform various user interface gestures to streamline digital wallet 106A management.

In an example, user interface (UI) management module 140 provides a user of a digital wallet software application with one or more visual cues or markers indicating a reward amounts including a greatest reward amount for cards of digital wallet assets 108A. For example, UI management module 140 may use various shapes and/or icons of various sizes and colors to represent and/or symbolize information about a card determined to be an optimal card for using in a transaction among the cards available in digital wallet assets 108A. For example, a first colored shape may indicate a greatest predicted reward amount for a card among digital wallet assets 108A while a different shape having a different color may indicate least predicted reward amount for a card among digital wallet assets 108A.

Request processor module 150 of digital wallet management system 130 receives various server machine 110, web server 120, application server, and/or client machine 102A-102N requests in some embodiments. For example, request processor module 150 may receive requests from a user of a client machine 102A to add various digital wallet assets 108A to digital wallet 106A. Request processor module 150 also may receive user requests to manage a digital wallet 106A and various digital wallet assets 108A.

In an example, digital wallet management module 160 of digital wallet management system 130 assists a digital wallet software application user in managing digital wallet assets 108A. For example, a digital wallet management module 160 may add, modify, arrange, organize, and/or remove digital wallet assets 108A with respect to one or more digital wallet(s) 106A. In some cases, digital wallet assets 108A may be modified, arranged, organized, and/or removed according to corresponding predicted reward amounts.

In an example, transaction processor module 170 of digital wallet management system 130 performs a transaction involving a digital wallet 106A. In one example, transaction processor module 170 automatically populates card information associated with a card of digital wallet assets 108A into a checkout user interface if the card has a greatest final reward prediction among available cards of digital wallet 106A.

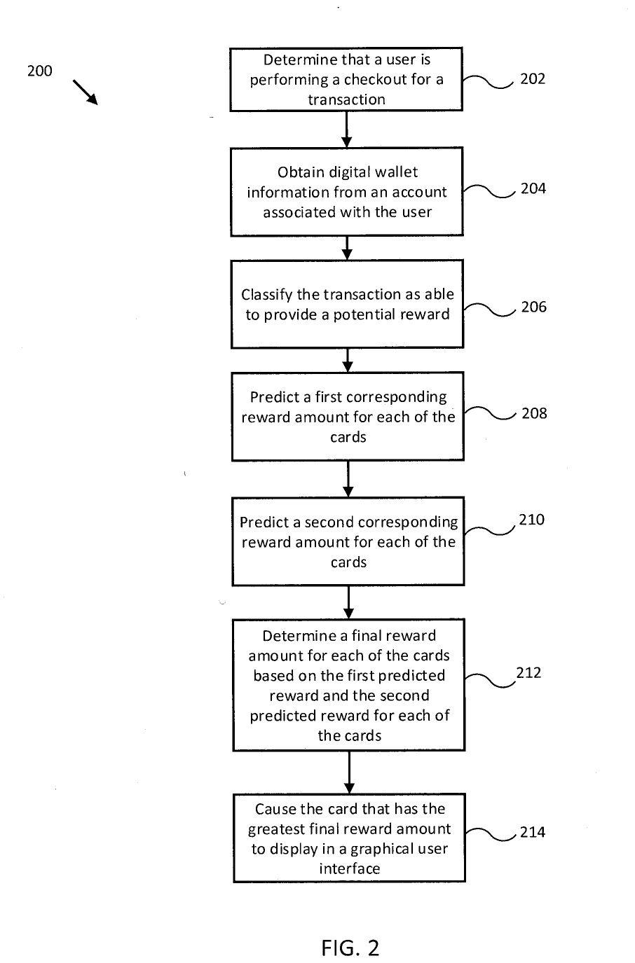

FIG. 2 illustrates a flow diagram of a process 200 for optimizing digital wallet rewards using reverse-engineering with machine-learning models in accordance with one or more embodiments of the present disclosure. The blocks of process 200 are described herein as occurring in serial, or linearly (e.g., one after another). However, multiple blocks of process 200 may occur in parallel. In addition, the blocks of process 200 need not be performed in the order shown and/or one or more of the blocks of process 200 need not be performed.

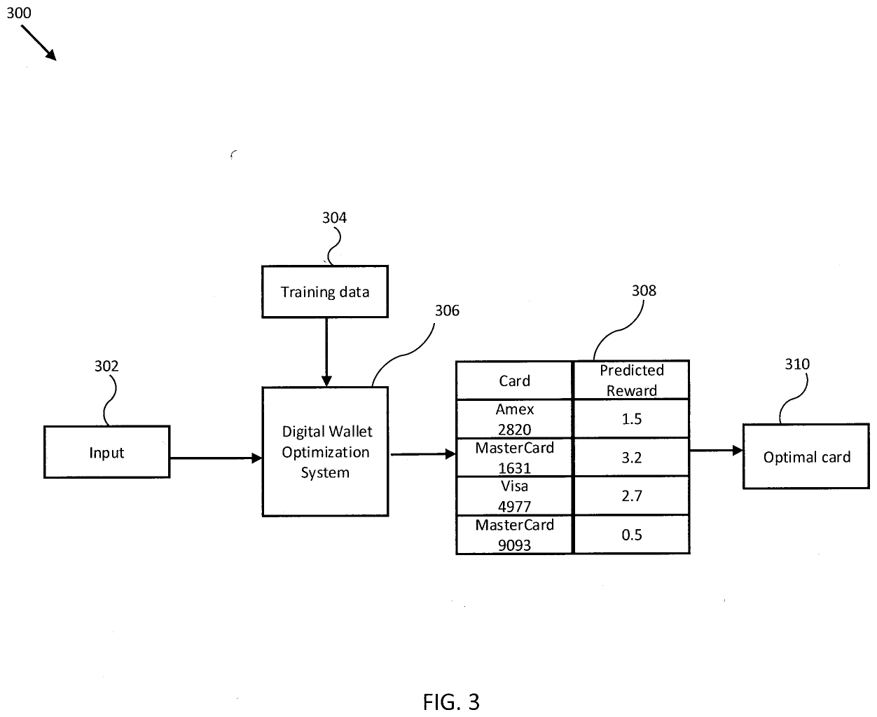

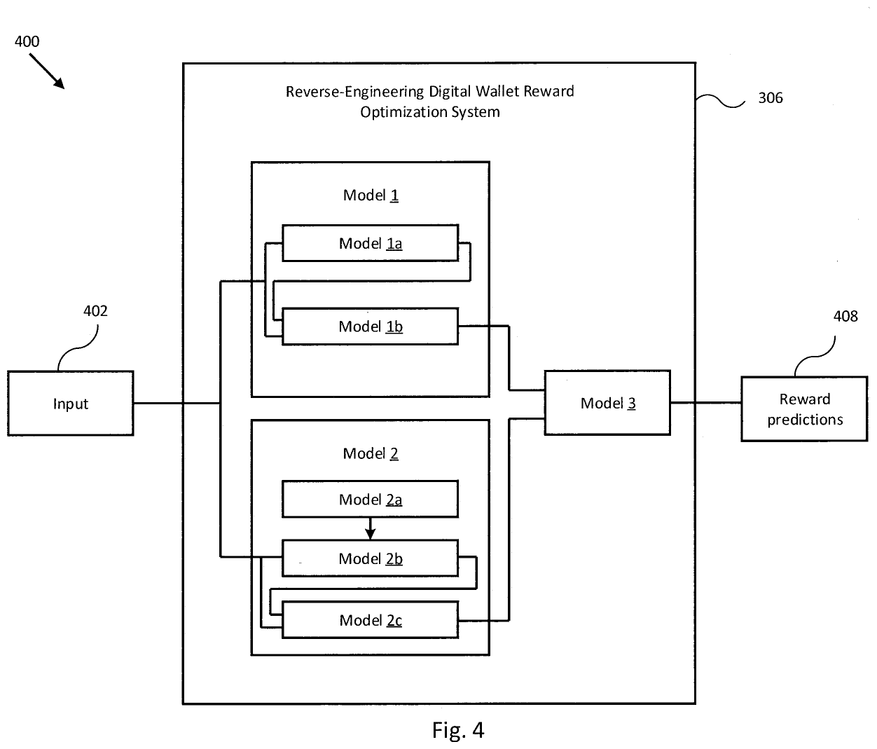

In operation 202, a system (e.g., digital wallet management system 130 or 130A of FIG. 1 or system 306 of FIG. 3 or 4) determines that a user is performing a checkout for a transaction. In some embodiments, the system may determine that the user is performing a checkout for a transaction by detecting that a Near Field Communication (NFC) contactless communication has occurred between a user device and a payment terminal for a merchant. In other embodiments, the system may identify that the user has navigated to a checkout interface in an application. For example, a user may be online shopping in an internet browser and has navigated to a checkout page for an e-commerce website. As another example, the user may be shopping in a mobile application and has clicked a checkout button in the mobile application, which may be an action that the system uses to determine that a checkout is being performed for a transaction. In some embodiments, the checkout for the transaction may be a mobile transfer of funds from a first user to a second user (e.g., a merchant) using a mobile payment application and not necessarily a purchase of goods or services. In various other embodiments, the system may determine that the user is performing the checkout for the transaction when a user has selected a payment method field in a checkout interface.

In operation 204, the system obtains digital wallet information from an account associated with the user. For example, the system may access digital wallet 106A and collect information associated with digital wallet assets 108A. The digital wallet information may include the various payment cards (e.g., funding instruments) linked to the digital wallet. Further details about each card may also be included in the digital wallet information. For example, card number or digital token identifier, card issuer, cardholder name, expiration date, security code, accumulated transaction reward amount, and card registration date may be included in the further details.

In operation 206, the system classifies whether the transaction is capable of providing a potential reward for one or more of the digital wallet cards. The transaction may be classified using a first sub-model of a first machine learning model that performs binary classification. In some embodiments, the first machine learning model may be trained using a training dataset that includes a card-specific campaign definitions and card-specific transaction data.

The campaign definition for a particular card may be received/retrieved from the card issuer for that particular card. In some cases, the campaign definition may be obtained from data scraped from a website that belongs to the card issuer and reformatted into a format suitable for a training dataset. The campaign definition may be from a text file that contains a campaign identifier (ID), campaign name, reward type (e.g., miles, cash back, and/or points), monetary value or an approximate monetary value if the reward type is miles or points, campaign start date and end date, opt-in required/optional, and a plain text detailed description of the campaign definition (e.g., prose form). In various embodiments, the system obtains a campaign definition for every card that could be linked to a digital wallet (e.g., the set of all cards that can be used in a transaction by existing users). Thus, each card may have a campaign definition. In cases, where a card's campaign definition cannot be found/imported/scraped from a source, a default campaign definition may be assigned to the card, where the default campaign definition results in zero rewards for all transactions.

The transaction data for a particular card may be aggregated from a large number of transactions performed by a large number of users. In some embodiments, a transaction processing service provider may have aggregated the transaction data for every card that has been used to perform a transaction through a platform of the service provider over a set period of time, such as a year or other period. The period can be revised or reset based on when a rewards program changes for a card. In this regard, transaction data for various cards may be crowdsourced from users that have performed transactions using a digital wallet or have performed transactions through the platform of the service provider. For example, the transaction data may include a transaction ID, funding instrument ID (e.g., card number or network token), card product name (e.g., Chase Sapphire Reserve®), digital wallet transaction ID, transaction date and time, transaction currency and value, merchant name, merchant category, campaign ID, number of rewards issued for the particular transaction (e.g., multiple rewards issued by same or different campaigns), and/or cumulative rewards issued at the time of the particular transaction over certain time periods (e.g., cumulative rewards for past month, three months, year, etc.). In various embodiments, the system obtains transaction data for every card that could be linked to a digital wallet (e.g., the set of all cards that can be used in a transaction by existing users). The system may disregard transaction data associated with rewards that are no longer offered by that particular card or modify the transaction data accordingly based on the new rewards.

Based on the file containing the campaign definition for each card and the file containing the transaction data for each card, a training dataset may be generated for the first sub-model of the first machine learning model to learn how to classify whether incoming transactions are able to produce a potential reward. In this regard, the first sub-model of the first machine learning model may be a binary classification model.

Thus, in operation 206, the first sub-model of the first machine learning model may receive as input transaction information derived from the ongoing transaction and digital wallet information associated with a digital wallet of the user. The first sub-model of the first machine learning model may classify the transaction as able to produce a potential reward or not able to produce a potential reward based on the transaction information and the digital wallet information. For example, the first sub-model may evaluate transaction information (e.g., characteristics) such as a transaction date and/or time, a transaction country and/or state, a transaction currency and value, a merchant involved in the transaction, and a merchant category code for the merchant. The first sub-model may further evaluate digital wallet card information (e.g., characteristics) such as campaign IDs for the various cards available in the digital wallet, names of the cards, and whether the user has opted-in to a reward campaign for the card. Based on the transaction information and digital wallet information satisfying conditions of campaigns of the digital wallet cards, the first sub-model may classify the transaction as able to return a potential reward.

To illustrate, the first sub-model may evaluate the transaction date and/or time of the transaction against each of the promotional campaigns (and associated conditions/rules) of available cards in the digital wallet to determine that the transaction date/time falls within a campaign start and end date. In another example, the transaction country and/or state of the transaction may be evaluated to be within a campaign's required country and/or state to receive a reward. In a further example, the merchant or merchant category code of the transaction may be evaluated to be within a campaign's required merchant or merchant category code to receive a reward. Another example includes evaluating the value/amount of the transaction to determine that it exceeds a threshold to receive a reward or evaluating an accumulated transaction amount to determine that it exceeds a threshold to receive a reward. Yet another example includes evaluating the opt-in status for a card to determine that a cardholder has opted-in to receive rewards for certain transactions such as transactions in certain categories or during certain time period. In other words, transaction information and digital wallet information may be evaluated against conditions/rules of a promotional campaign for each of the digital wallet cards to determine whether the transaction will produce a reward for using a card corresponding to the promotional campaign. The above conditions/rules may be combined in various ways according to some embodiments.

If the first sub-model of the first machine learning model outputs that the transaction is able to produce a potential reward for one or more cards of the digital wallet (e.g., a “true” binary output from the first sub-model of the first machine learning model), process 200 may proceed to operation 208.

In operation 208, a second sub-model of the first machine learning model may predict a first potential reward amount for each of the cards in the digital wallet available for the transaction that produced a “true” in operation 206 as being able to produce a potential reward. The second sub-model of the first machine learning model may receive as input the transaction information and digital wallet information to predict the first potential reward amounts for each of the cards.

To illustrate, the second sub-model may receive as input a transaction amount of $100 for a hotel category purchase in a current transaction. In an example case, if the first sub-model returned a “true” for satisfying conditions for three digital wallet cards, the second sub-model may predict a potential reward for each of the three digital wallet cards. For example, a first card may be a 2% cash back card, a second card may be a 3× points reward card for restaurant category purchases and 1× points for other merchant category purchases, and a third card may be a card that rewards $150 for spending $2000 within a first three-months of registering the third card. In the example, the second-sub model may return a prediction of $2 cash back for the first card based on the transaction amount of $100. The second sub-model may return a prediction of $1 (approximated value of 100 points) for the second card as the purchase is in a hotel category not a restaurant category. The second sub-model may return a prediction of $150 for the third card if, for example, the transaction amount of $100 plus the accumulated transactional total for the third card exceeds $2000 within the three-month time period subsequent to registering the third card.

In various embodiments, the second sub-model of the first machine learning model may learn from training datasets. The training datasets may include one or more items from the campaign definition and aggregated transaction data discussed above. In one or more embodiments, the second sub-model of the first machine learning model may be a regression model. For example, the second sub-model may undergo supervised learning to learn a mapping function from input transaction information and digital wallet information to reward outputs. By learning the rules for various campaigns corresponding to digital wallet cards based on aggregated transaction training datasets, the second sub-model does not need to rely on updates to campaign definitions from card issuers regarding rule changes such as switching a cash back amount from 2% of a transaction amount down to 1%, for example.

In operation 210, a second machine learning model may predict a second potential reward amount corresponding to each of the cards of the digital wallet. Predicting a second potential reward amount in a different fashion from the first predicted potential reward amount allows for comparison to validate and improve performance as discussed herein.

In some embodiments, the second machine learning model may comprise sub-models. A first sub-model of the second machine learning model may be a classification model that extracts campaign conditions/rules for cards (e.g., all existing cards issued by card issuers) from their corresponding plain text campaign descriptions. For example, the campaign descriptions may be part of campaign definitions imported from various sources such as files received from card issuers or payment service providers and/or data scraped from websites such as promotional campaign description websites hosted by card issuers. The extraction may involve text summarization in some instances. For example, text summarization may include converting paragraphs of the campaign descriptions into sentences. The sentences may be processed to remove stop words such as “and” or “the.” The sentences may be tokenized to obtain all the words present in the sentences and formatted such that the words are converted to a list form. The words may be evaluated to determine a weighted occurrence frequency of each word. The words may then be substituted with their weighted frequencies and summed in each sentence to deduce sentences that carry the most weight. The sentences that carry the most weight may be the conditions/rules of the campaign description in some embodiments.

A second sub-model of the second machine learning model may be a binary classification model that uses the extracted conditions from the first sub-model to make a binary classification of the transaction based on digital wallet information and transaction information for each card of the digital wallet. For example, for each card, the second sub-model may determine whether the card's extracted conditions for its corresponding campaign have been satisfied by the current transaction. In this regard, the second sub-model of the second machine learning model may be operatively similar to the first sub-model of the first machine learning model.

If the second sub-model classifies the transaction as “true” as likely to produce a potential reward for any of the cards, a third sub-model of the second machine learning model may predict the reward amount for each card likely to produce a potential reward in the digital wallet. For example, the third sub-model may use the extracted rules determined by the first sub-model of the second machine learning model to predict the reward amounts for each card. For example, an extracted rule may include a reward function that outputs a reward amount for an input unit of currency spent. For example, a reward function may be $0.02 earned per $1.00 spent for every transaction. Another extracted rule may be that after spending $4000 within three months of registering a card, a $200 sign-up bonus reward may be issued. In this regard, the input may include an accumulated transaction amount, transaction date, and card registration date and the output may be $200. Another extracted rule may be that 3 points are earned for every $1 spent in specified merchant categories such as restaurants or at specified merchants such as specific hotels. In this regard, the input may include a transaction amount and a merchant category, and the output may be a reward amount relative to that merchant category and transaction amount.

Thus, in operation 210, a second prediction is made for each of the cards by the second machine learning model. A first prediction from the first machine learning model and a second prediction from the second machine learning model may then be outputted. The predictions may be generated concurrently by the machine learning models in some cases.

In operation 212, an ensemble machine learning model evaluates the first prediction outputted by the first machine learning model and the second prediction outputted by the second machine learning model to determine a final predicted reward amount for each of the cards.

In some instances, the ensemble machine learning model may be a bagging model that evaluates the performance of the first machine learning model and the performance of the second machine learning model to determine the final prediction. In this regard, the ensemble machine learning model may determine when to use the prediction of the first machine learning model or the prediction of the second machine learning model or when to combine predictions (e.g., create an average or weighted-average prediction) by comparing the respective performances of the models. In some cases, the ensemble machine learning model may perform the determination as to which model to use or whether to combine predictions by the models based on minimization of variance or reduction of bias.

According to various embodiments, the system may analyze the final predicted reward amounts for each of the cards to determine which card has the greatest final predicted reward amount. For example, the final predicted reward amounts may be compared to determine a greatest reward amount. The card corresponding to the greatest reward amount may be an optimal card for the transaction.

In operation 214, the system causes the optimal card that has the greatest final predicted reward amount to be indicated in a graphical user interface associated with the checkout process of the transaction. The graphical user interface may be configured to allow for the optimal card to be selected for use in the transaction. In some embodiments, if the optimal card is selected, the system may automatically populate a payment method input field in the graphical user interface with card information such as a card number (e.g., network token), a cardholder name, an expiration date, a security code, and/or billing address. The graphical user interface features may also be performed with respect to the other available cards in the digital wallet, however, a recommendation may be provided in the graphical user interface indicating that the optimal card has the greatest final predicted reward amount compared to the other available cards.

In some embodiments, subsequent to a processing of the transaction, a transaction history of the digital wallet may be monitored to determine an actual reward resulting from use of any card in the transaction. The actual reward result may be used as feedback for training purposes for future versions of the system. For example, the actual reward result and corresponding transaction information may be saved/stored to a training database (e.g., data store 180) and provided as another aggregated training example for future training datasets. In this regard, the system may be updated based on new aggregated training data from the completed transaction as well as other aggregated completed transactions from other users, thus allowing for the system to frequently update as new reward rules are implemented and pushed out by card issuers.

FIG. 3 illustrates a flow diagram of a process 300 for optimizing digital wallet rewards using reverse-engineering in accordance with one or more embodiments of the present disclosure. In the embodiment shown in FIG. 3, a system 306 receives training data 304, which system 306 learns in order to make reward predictions 308 based on an input 302. In some embodiments, system 306 may be, may be part of, or may include digital wallet management system 130 or 130A of FIG. 1.

According to various embodiments, system 306 may import training data 304. The training data may contain external raw data that may be used to train system 306. Training data may be one or more files imported from one or more sources. For example, training data 304 may include a file(s) imported from a card issuer(s). Files imported from card issuers may include promotional campaign definitions corresponding to card products provided by the card issuers. For example, Chase bank may provide a campaign definition for their Chase Sapphire Reserve® card product.

A campaign definition may contain a campaign ID and name, a reward type (e.g., miles cash back, or redeemable points), monetary value per reward (e.g., approximate monetary value if reward is miles or points), campaign start and end dates, opt-in requirement, detailed campaign definition (e.g., plain text campaign description), etc.

As another example, training data 304 may include a file(s) imported from a payment service provider such as PayPal. In some cases, the payment service provider may also be the card issuer. A file(s) imported from the service provider may contain transaction information related to rewards issued for transactions such as digital wallet transactions. For example, transaction information may include a transaction ID, card ID (e.g., card number or network token), card product name (e.g., Amex Platinum Card®), service provider transaction ID (if a service provider digital wallet transaction), transaction date and time, transaction currency and value, merchant ID and/or name, merchant category (e.g., merchant category code or name such as restaurant, gas, groceries, entertainment, etc.), campaign ID, number of rewards issued for the transaction by the specified campaign (e.g., multiple campaigns trigger rewards in a single transaction), cumulative issued rewards at the time of the transaction for a specified campaign (e.g., campaign provides reward for spending a certain dollar amount within a certain time period, e.g., spending $3000 within three months of opening a line of credit with a new card may result in 30,000 points rewarded).

According to various embodiments, system 306 may be trained using training data 304. System 306 may determine that a transaction is being conducted by a user. For example, a user may be conducting a transaction in an application on a computing device and may be at a checkout process in a transaction. System 306 may automatically determine that the user is at the checkout process and provide prediction 308, which may include predicted reward amounts for cards in the digital wallet. System 306 may further provide recommendation 310 for an optimal card to use in the transaction based on input 302. Input 302 may include information specific to the transaction and available digital wallet information. For example, input 302 may include digital wallet information such as a campaign ID, card product name, and/or opt-in status for each card in the digital wallet. Input 302 may further include transaction information for the current transaction such as a transaction date and time, transaction location (e.g., country, state, etc.), transaction currency and value, and merchant ID and/or name and merchant category code of the merchant involved in the transaction.

As shown in FIG. 3, system 306 may output prediction 308, which may be displayed in a graphical user interface of the computing device. Card names/card IDs and corresponding predicted reward amounts are shown in prediction 308 of FIG. 3 as illustrative examples. The predicted reward amounts may be in a form of currency that matches the transaction currency, or the predicted reward amounts may be in a form of points/miles according to various embodiments.

FIG. 4 illustrates is a block diagram of a system architecture 400 suitable for optimizing digital wallet rewards using reverse-engineering in accordance with one or more embodiments of the present disclosure. The system architecture 400 may include a model 1, a model 2, and a model 3. Model 1 may include sub-models 1a and 1b. Model 2 may include sub-models 2a, 2b, and 2c.

In some embodiments, sub-model 1a may be a binary classification machine learning model. Sub-model 1a may be trained using training data imported from various sources. For example, sub-model 1a may be trained using training data discussed above in reference to FIG. 3. After sub-model 1a has been trained, sub-model 1a may be executed in system 306 to output binary classifications of incoming transactions. For example, input 402 may include incoming transaction data comprising digital wallet information and transaction information specific to the incoming transaction. In some embodiments, input 402 may be, may be part of, or may include input 302 of FIG. 3. Based on input 402 data, sub-model 1a may classify the incoming transaction as “true” or “false” for one or more cards in the digital wallet of a user conducting the transaction. A “true” classification may mean that the transaction satisfies campaign rules of the card and is likely to provide a potential reward. A “false” classification may mean that the transaction is not likely to provide a potential reward for the card for failing to satisfy the rules.

In some embodiments, the output of sub-model 1a may be fed to sub-model 1b. If sub-model 1a returns a “true” classification of the incoming transaction for one or more cards, the “true” classification may enable sub-model 1b to predict one or more reward amounts corresponding to the cards with “true” classifications for the transaction. Thus, at least one “true” classification by sub-model 1a may enable operation of sub-model 1b according to some embodiments. If sub-model 1a returns a “false” classification output for each card, sub-model 1b may abstain from predicting reward amounts or produce a zero or null output as the transaction is unlikely to produce a reward for any of the cards of the digital wallet.

Sub-model 1b may be trained to predict reward amounts based on training datasets aggregated from a plurality of previous transactions conducted by a plurality of users (e.g., data file imports from payment service providers and/or card issuers). For example, sub-model 1b may be a machine learning model that uses a regression algorithm to predict reward amounts. Various regression algorithms may be used, for example, Linear, Logistic, Polynomial, Stepwise, Ridge, Lasso, and/or ElasticNet regression algorithms are contemplated for implementing one or more embodiments suitable to predict the reward amounts.

Various characteristics of the current transaction and cards of the digital wallet may be provided as input to sub-model 1b from input 402. For example, a card product name, merchant category, transaction amount and currency may be used by sub-model 1b to predict a reward amount. For example, sub-model 1b may use a learned mapping to map such characteristics to a predicted reward amount. Additional transaction characteristics and card characteristics as discussed above may be used by sub-model 1b to make a prediction according to some embodiments.

The predicted reward amounts from sub-model 1b for each of the digital wallet cards may be fed to model 3. The predicted reward amounts from sub-model 1b may be a first set of predicted reward amounts for cards of the digital wallet according to some embodiments.

Model 2 may predict a second set of reward amounts independent from model 1. In some embodiments, model 1 and model 2 operate concurrently and independently. The second set of predicted reward amounts for cards of the digital wallet may be fed to model 3 from model 2, according to one or more embodiments. Model 2 may comprise sub-models used in conjunction to predict the second set of reward amounts.

For example, sub-model 2a of Model 2 may be a classification machine learning model that has been trained to output a summary of campaign rules corresponding to cards available to all users. Sub-model 2a may receive a file import from one or more card issuers where the files provide campaign definitions of respective cards promoted by the card issuers. Sub-model 2a may further analyze the campaign definition to generate a rule set for each campaign. As a further example, the campaign definition for each card may be a plain text detailed description of a card, and sub-model 2 may generate a summarized rule set from the plain text detailed description. Thus, sub-model 2a extracts rules for cards based on campaign definitions. The rules may include conditions that must be satisfied for a reward to be issued and a reward function to determine how the reward is calculated. In some cases, sub-model 2a may be the first sub-model of the second machine learning model discussed in reference to FIG. 2.

The extracted rules for the cards may be made available or provided to sub-model 2b. Sub-model 2b may use the extracted rules to make a binary classification of the incoming transaction. That is, sub-model 2b may evaluate whether characteristics of the incoming transaction satisfy the extracted rules corresponding to campaigns of the digital wallet cards. In this regard, sub-model 2b may be operatively similar to sub-model 1a.

The output of sub-model 2b may be fed to sub-model 2c according to various embodiments. If sub-model 2b returns a “true” classification of the incoming transaction for one or more cards of the digital wallet, the “true” classification may enable sub-model 2c to predict one or more reward amounts corresponding to the one or more cards of the digital wallet. In this regard, at least one “true” classification output from sub-model 2b may enable operation of sub-model 2c. Conversely, if sub-model 2b returns a “false” classification output for each of the cards of the digital wallet, sub-model 2c may abstain from predicting reward amounts or predict a zero reward amount for each digital wallet card according to some embodiments.

Sub-model 2c may predict reward amounts for each digital wallet card with a “true” classification based on extracted campaign rules provided by sub-model 2a. For example, an extracted rule may include a reward function that provides an output reward amount for an input transaction amount. For example, a reward function may be $0.02 is earned per every $1.00 spent. Another extracted rule may be a reward amount is issued after a user has exceeded an accumulated transaction threshold amount (e.g., reward of 60,000 bonus points after spending $10,000 within the first year of registering the card). Another extracted rule may be progressive rewards based on category and transaction amount (e.g., 4% cash back for rideshare transactions, 3% cash back for entertainment transactions, 2% cash back for dining transactions, and 1% cash back for all other categorized transaction).

The predicted reward amounts from sub-model 2c for each of the digital wallet cards may be fed to model 3. In this regard, the predicted reward amounts from sub-model 2c may be the second set of predicted reward amounts according to one or more embodiments.

Model 3 may receive the first set of predicted reward amounts from model 1 and the second set of predicted reward amounts from model 2. Model 3 may be an ensemble (e.g., meta) model such as a bagging model that evaluates a performance of model 1 versus a performance model 2 based on available transaction characteristics/attributes to improve optimization results of system 306. For example, model 3 may learn when to use model 1 over model 2 or when to use model 2 over model 1. In some cases, model 3 may use the first set of predicted reward amounts and the second set of predicted reward amounts to determine a final predicted reward amount that is one of the predicted reward amounts or a combination of the predicted reward amounts (e.g., an average or weighted average of the first predicted reward amount and the second predicted reward amount). For example, a greater weight may be given to the second predicted reward amount when aggregated transaction data used to train model 1 is limited (e.g., below a threshold number of previous transactions) as less aggregated data may be less reliable as opposed to more aggregated data.

Model 1, model 2, and model 3 provide for a distributed architecture that allows for independent prediction sets from multiple machine learning models that can be combined to improve performance of system 306 in terms of accuracy and reliability by reducing noise, bias, and/or variance. For example, when system 306 has incomplete or inaccurate raw data from external sources (e.g., payment service providers, card issuers), the multiple prediction sets may allow for model 3 to cross-check and evaluate performance of the models to determine a final prediction for each card that is likely to be more accurate.

Overfitting occurs when a model learns the detail and noise in training data to the extent that it negatively impacts the performance of the model when given new data because noise or random fluctuations in the training data is picked up and learned as concepts by the model. Underfitting may refer to a model that can neither model the training data nor generalize to new data. The distributed architecture of system 306 allows for model 1 and model 2 of system 306 to be exposed to different data sets. By utilizing collective outputs at model 3, overfitting or underfitting errors may be reduced or mitigated, thus resulting in improved computational performance.

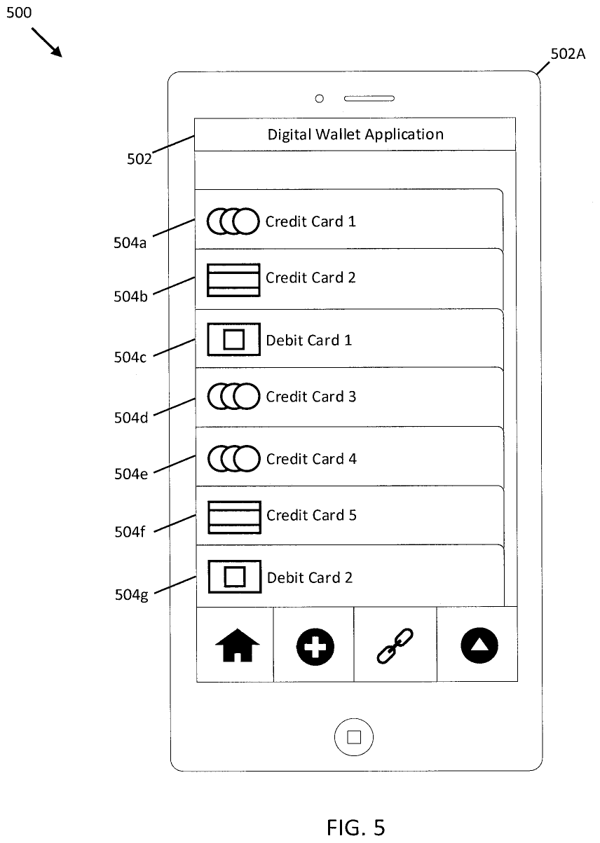

Model 3 may output a final predicted reward for each of the digital wallet cards available for the transaction at output 408 of system 306. In some embodiments, output 408 may cause a user device to display the digital wallet cards and their corresponding final predicted rewards in a graphical user interface (e.g., graphical user interface 500 of FIG. 5) as a recommended card for the transaction.

FIG. 5 illustrates a graphical user interface 500 for displaying a digital wallet in a digital wallet application 502 on a user device 502A in accordance with one or more embodiments of the present disclosure. Cards 502a-502g may be funding instruments linked to a user account active in digital wallet application 502.

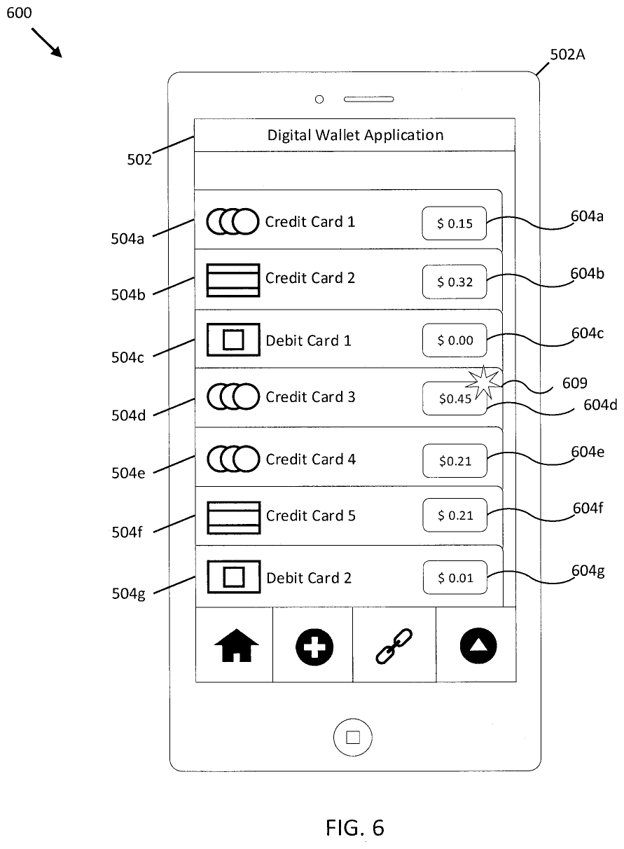

In the embodiment shown in graphical user interface 600 of FIG. 6, final reward predictions 604a-604f may be displayed adjacent to cards names of cards 504a-504g. In some embodiments, when a user is at a checkout interface in a transaction, digital wallet application may display cards 504a-504g and final reward predictions 604a-604f outputted by system 306. In some embodiments, system 306 may cause an indicator 609 to be displayed in graphical user interface 600. Indicator 609 may provide a notice to a user that the indicated card (e.g., card 504d) has the greatest predicted reward amount of the available digital wallet cards 504a-504g.

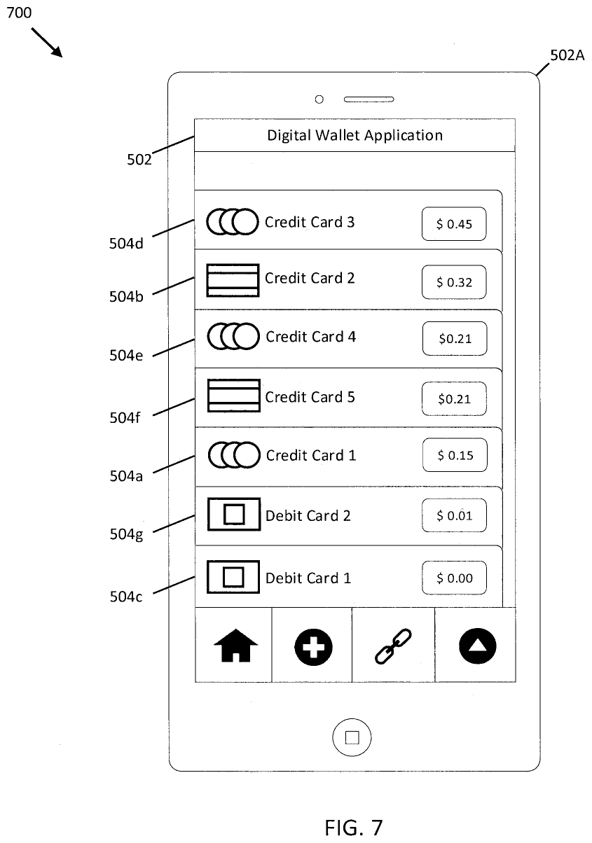

In some embodiments, after the reward amounts are predicted for each card for the transaction, the digital wallet cards 504a-504g may be rearranged into a list. The list may display the cards 504a-504g in a descending order or an ascending order in some cases. For example, FIG. 7 illustrates a graphical user interface 700 in which cards 504a-504g are rearranged to be displayed in a descending order with card 504d having the greatest predicted reward amount at the top and card 504c having the least predicted reward amount at the bottom. In another embodiment, only select cards with rewards are displayed to reduce content displayed on a device. For example, only the cards with the three top or highest value rewards are shown, which may be a more efficient use of the display. The digital wallet cards 504a-504g may further be arranged or rearranged according to reward type. For example, predicted reward amounts that are in the form of points may be displayed at a top of a list, predicted reward amounts that are in the form of currency of the transaction may follow the predicted reward amounts in points. In another embodiment, only the top three cards most frequently used by the user (such as over a certain time period) are shown with their associated predicted reward amounts. In this regard, various machine learning algorithms discussed herein may provide predicted reward amounts that may be employed in controlling specific display features and operations in a user interface displayed on a screen of a user device.

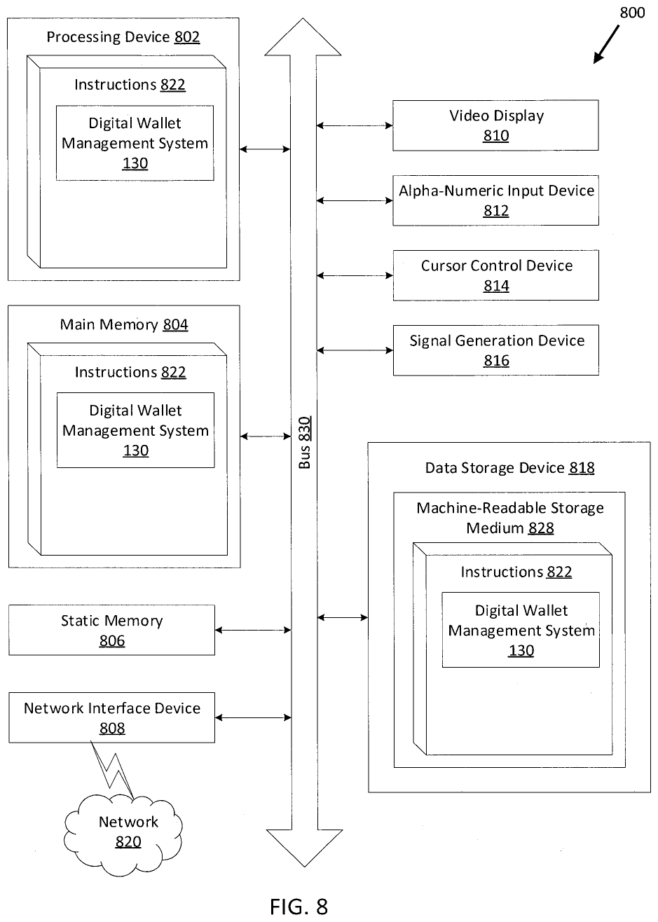

FIG. 8 illustrates a diagram of a machine in the exemplary form of a computer system 800, within which a set of instructions for causing the machine to perform any one or more of the methodologies discussed herein may be executed. In other examples, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a wearable computing device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 818, which communicate with each other via a bus 830.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 also may be one or more special-purpose processing devices such as an application specific integrated circuit (ASIC), a field programmable gate array (FPGA), a digital signal processor (DSP), network processor, or the like. The processor 802 is configured to execute instructions 822 for performing the operations and steps discussed herein.

The computer system 800 also may include a network interface device 808. The computer system 800 may further include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 may include a computer-readable storage medium 828 on which is stored one or more sets of instructions 822 (e.g., software computer instructions) embodying any one or more of the methodologies or functions described herein. The instructions 822 also may reside, completely or at least partially, within the main memory 804 and/or within the processor 802 during execution thereof by the computer system 800, the main memory 804 and the processor 802 also constituting computer-readable storage media. The instructions 822 may be transmitted or received over a network 820 via the network interface device 808.

In one example, the instructions 822 include instructions for one or more modules of a digital wallet management system (e.g., digital wallet management system 130 of FIG. 1) and/or a software library containing methods that call a digital wallet management system 130. While the computer-readable storage medium 828 (machine-readable storage medium) is shown as an example to be a single medium, the term “computer-readable storage medium” should be taken to include a single medium or multiple media (e.g., a centralized or distributed database, and/or associated caches and servers) that store the one or more sets of instructions. The term “computer-readable storage medium” also may include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Numerous details are set forth in the foregoing description. However, it will be apparent to one of ordinary skill in the art having the benefit of this disclosure that the present disclosure may be practiced without these specific details. In some instances, well-known structures and devices are shown in block diagram form, rather than in detail, to avoid obscuring the present disclosure.

Some portions of the detailed description have been presented in terms of algorithms and symbolic representations of operations on data bits within a computer memory. Here, an algorithm is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “associating”, “applying”, “transmitting”, “receiving,” “processing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system, comprising:
a non-transitory memory; and
one or more hardware processors coupled to the non-transitory memory and configured to read instructions from the non-transitory memory to cause the system to perform operations comprising:
determining that a user device associated with a user is performing a checkout for a transaction;
obtaining digital wallet information from an account associated with the user, wherein the digital wallet information comprises data associated with cards;
classifying, using a first sub-model of a first machine learning model, the transaction as satisfying campaign reward rules for a set of the cards based on transaction information associated with the transaction;
predicting, using a second sub-model of the first machine learning model, a first preliminary reward amount for each of the set of cards based on the transaction information;
predicting, using a second machine learning model, a second preliminary reward amount for the set of cards based on rules extracted using the second machine learning model;
determining, using a third machine learning model, a predicted reward amount for each of the set of cards based on the first preliminary reward amount for each of the set of cards and the second preliminary reward amount for the set of cards; and
causing a card having a greatest predicted reward amount to display in a graphical user interface of the user device as a recommended card.

2. The system of claim 1, wherein the first sub-model is trained using a training dataset comprising a campaign definition corresponding to each of the set of cards.

3. The system of claim 2, wherein the campaign definition includes a campaign identifier, a reward type, a monetary value for a reward, a campaign start date and a campaign end date, and an opt-in status.

4. The system of claim 1, wherein the second sub-model is trained using a training dataset comprising historic reward data associated with the set of cards, and wherein the historic reward data is aggregated from a plurality of user accounts.

5. The system of claim 4, wherein the historic reward data comprises information associated with a plurality of transactions, wherein each of the plurality of transactions comprises a transaction identifier, a card identifier, a name of a utilized card, a transaction date, a transaction time, a transaction currency, a transaction value, a merchant name, a merchant category, a campaign identifier, a number of issued rewards, and a cumulative issued rewards.

6. The system of claim 1, wherein the operations further comprise:
extracting, using a first sub-model of the second machine learning model, the rules from a campaign definition corresponding to each of the set of cards; and
classifying, using a second sub-model of the second machine learning model, the transaction as satisfying the extracted rules based on the transaction information associated with the transaction, wherein the predicting, using the second machine learning model, is performed by a third sub-model of the second machine learning model.

7. The system of claim 6, wherein the first machine learning model and the second machine learning model operate independently in performing respective predictions.

8. The system of claim 1, wherein the third machine learning model comprises a bagging algorithm that evaluates a performance of the first machine learning model and a performance of the second machine learning model.

9. The system of claim 1, wherein the transaction information comprises a transaction amount, a transaction currency, a transaction time, and a merchant identifier.

10. The system of claim 1, wherein the extracted rules comprise a reward function used to calculate a reward issued per unit spent using each of the set of cards, a minimum transaction value for the reward to be issued, and acceptable merchant identifier categories for the reward to be issued.

11. The system of claim 10, wherein the rules are extracted by data scraping campaign descriptions from a website corresponding to each of the set of cards.

12. A method comprising:
determining that a user account is in a checkout process for a transaction;
retrieving a digital wallet associated with the user account;
classifying, using a first sub-model of a first machine learning model, the transaction as able to provide a reward for a set of cards of the digital wallet;
in response to the transaction being classified as able to provide the reward for the set of cards, predicting, using a second sub-model of the first machine learning model, a first reward amount corresponding to each card of the set of cards;
predicting, using a second machine learning model, a second reward amount corresponding to each card of the set of cards;
determining, using a third machine learning model, a third reward amount for each card of the set of cards based on the predicted first reward amount and the predicted second reward amount;
determining a greatest reward amount of the third reward amounts; and
causing a card corresponding to the greatest reward amount to display in a graphical user interface of the user account for selection in the checkout process.

13. The method of claim 12, further comprising:
receiving a user selection of the card corresponding to the greatest reward amount;
processing the transaction using the card corresponding to the greatest reward amount;
determining an actual reward resulting from a use of the card corresponding to the greatest reward amount; and
training the second machine learning model based on a training dataset that includes the actual reward.

14. The method of claim 12, further comprising:
receiving a plurality of files corresponding to the set of cards, wherein each file comprises a campaign definition associated with a card from the set of cards; and
training the first sub-model of the first machine learning model using a training dataset comprising the campaign definitions.

15. The method of claim 12, further comprising rearranging a list of the set of cards in the graphical user interface into a descending order according to the third reward amount corresponding to each of the set of cards.

16. The method of claim 12, wherein the predicting the first reward amount is based on transaction information associated with the transaction and historic transaction information obtained from a plurality of user accounts and learned by the second sub-model of the first machine learning model.

17. A non-transitory machine-readable medium having stored thereon machine-readable instructions executable to cause a machine to perform operations comprising:
determining that a transaction is at a checkout process of the transaction;
obtaining cards of a digital wallet associated with a user account of a user in the transaction;
classifying, using a first sub-model of a first machine learning model, the transaction as able to produce a potential reward for a set of the cards;
in response to the classifying the transaction as able to produce the potential reward for the set of the cards, predicting, using a second sub-model of the first machine learning model, a first reward amount corresponding to each card of the set of the cards;
predicting, using a second machine learning model, a second reward amount corresponding to each card of the set of the cards;
predicting, using a third machine learning model, a third reward amount for each card of the set of the cards based on the predicted first reward amount and the predicted second reward amount;
determining a card having a greatest third reward amount; and
indicating the card having the greatest third reward amount in a graphical user interface associated with the checkout process as a recommended card.

18. The non-transitory machine-readable medium of claim 17, wherein the operations further comprise arranging the cards of the digital wallet in a descending manner according to the third reward amount for each card.

19. The non-transitory machine-readable medium of claim 17, wherein the operations further comprise:
obtaining transaction information of the transaction, wherein the transaction information comprises a merchant category, a transaction date, and a transaction amount; and
providing the transaction information to the first sub-model of the first machine learning model, the second sub-model of the first machine learning model, and the second machine learning model, wherein the first machine learning model and the second machine learning model operate independently.

20. The non-transitory machine-readable medium of claim 19, wherein the third machine learning model comprises an ensemble model, and wherein the predicting the third reward amount comprises evaluating, using the ensemble model, a performance of the first machine learning model and a performance of the second machine learning model to determine the third reward amount.
